(19) United States
(12) Patent Application Publication
(10) Pub. No.: US 2018/0266984 A1
(43) Pub. Date: Sep. 20, 2018

(54) ELECTROCHEMICAL SENSOR AND ELECTRONICS ON A CERAMIC SUBSTRATE

(71) Applicant: Honeywell International Inc., Morris Plains, NJ (US)

(72) Inventors: Keith Francis Edwin Pratt, Portsmouth (GB); John Chapples, Portsmouth (GB); Steve Scorfield, Zurich (CH)

(21) Appl. No.: 15/781,537

(22) PCT Filed: Nov. 16, 2016
(86) PCT No.: PCT/US2016/062196

§ 371 Date: Jun. 5, 2018

Related U.S. Application Data
(60) Provisional application No. 62/265,018, filed on Dec. 9, 2015.

(51) Int. Cl. G01N 27/407; G01N 27/403; G01N 27/404

(52) U.S. Cl. CPC G01N 27/4071; G01N 27/4045; G01N 27/4035

(57) ABSTRACT

An electrochemical sensor includes a ceramic substrate, a capillary disposed through the ceramic substrate, a plurality of electrodes disposed on a first surface of the ceramic substrate, an electrolyte disposed over at least a portion of each electrode of the plurality of electrodes, a coating disposed over the plurality of electrodes and the electrolyte, and control and detection circuitry coupled to the substrate. The coating sealingly couples to the substrate over the plurality of electrodes and the electrolyte, and the plurality of electrodes are electrically coupled to the control and detection circuitry.

### CROSS-REFERENCE TO RELATED APPLICATIONS

This application claims the benefit of and priority to U.S. Provisional Application No. 62/265,018 filed on Dec. 9, 2015 and entitled “Electrochemical Sensor and Electronics on Ceramic Substrate” by Keith Francis Edwin Pratt et al., which is incorporated herein by reference in its entirety.

### BACKGROUND

Electrochemical sensors can be used to detect various types of gases including oxygen as well as other types of gases. The electrochemical sensors are generally formed within housings maintaining a liquid electrolyte. External electrical connections are formed through connection pins that allow the sensors to be electrically coupled to external circuitry. The resulting sensor assembly is generally relatively large. The overall size can also contribute to signal degradation between the electrochemical sensor itself and the external processing circuitry.

### SUMMARY

In an embodiment, an electrochemical sensor comprises a ceramic substrate, a capillary disposed through the ceramic substrate, a plurality of electrodes disposed on a first surface of the substrate, an electrolyte disposed over at least a portion of each electrode of the plurality of electrodes, a coating disposed over the plurality of electrodes and the electrolyte, and control and detection circuitry coupled to the substrate. The coating sealingly couples to the substrate over the plurality of electrodes and the electrolyte, and the plurality of electrodes are electrically coupled to the control and detection circuitry.

In an embodiment, an electrochemical sensor comprises a ceramic substrate, one or more capillaries disposed through the ceramic substrate, a plurality of electrodes disposed on a first surface of the substrate, a solid electrolyte disposed over at least a portion of each electrode of the plurality of electrodes, and control and detection circuitry coupled to the substrate. The one or more capillaries form the only opening between an external environment and the plurality of electrodes, and the plurality of electrodes are electrically coupled to the control and detection circuitry.

In an embodiment, a method of forming an electrochemical sensor on a substrate comprises forming one or more capillaries through a ceramic substrate, forming a plurality of electrical connection tracks on the ceramic substrate, coupling control and detection circuitry to the substrate, forming a plurality of electrodes on a first surface of the substrate, disposing a solid electrolyte over at least a portion of each of the plurality of electrodes, encapsulating the solid electrolyte and the plurality of electrodes, and sealing the plurality of electrodes and the electrolyte from an external environment based on the encapsulation, wherein the one or more capillaries form the only opening between the external environment and the plurality of electrodes. The control and detection circuitry is electrically coupled to the plurality of electrical connection tracks, and the plurality of electrodes are in electrical communication with the control and detection circuitry.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 schematically illustrates a cross-sectional view of a sensor according to an embodiment.

FIG. 2 schematically illustrates another cross-sectional view of a sensor according to an embodiment.

FIG. 3 schematically illustrates a close up cross-sectional view of a sensor and a capillary according to an embodiment.

FIG. 4 schematically illustrates a close up cross-sectional view of a sensor and a plurality of capillaries according to an embodiment.

FIG. 5 schematically illustrates a sensor on a circuit board according to an embodiment.

FIG. 6 schematically illustrates still another cross-sectional view of a sensor according to an embodiment.

FIG. 7 schematically illustrates another sensor on another circuit board according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Disclosed herein are electrochemical sensors that may have a reduced power consumption relative to standard sensors. Various embodiments include a micro electromechanical system (MEMS) gas sensor. A MEMS sensor can have a relatively small size compared to standard electrochemical gas sensors. MEMS sensors may have the advantage of using semiconductor manufacturing techniques to form the sensors. These techniques may provide for a reliable and repeatable formation process that can produce high quality sensors. Further, the small size of the MEMS devices may reduce the overall power requirements for the sensor. For example, a relatively small capillary can be formed in a semiconductor substrate, which allow for a controlled diffusion rate of a gas being detected, such as oxygen. The relatively low diffusion rate may then limit the power requirements to detect a current between the electrodes in the sensor. In some embodiments, potentiometric type sensors can also be formed using the MEMS type devices.

The use of small components may also aid in retaining the electrolyte in the MEMS sensor. The small and controlled formation of the capillary may allow the capillary to be formed through the substrate directly into the sensing electrode. A gas, electrode, electrolyte interface can then be formed at the electrode surface. This may limit the diffusion of the electrolyte out of the MEMS sensor and/or the ingress or egress of water (e.g., as humidity) into the MEMS sensor, which may extend the overall life of the sensor.

In other embodiments, the electrochemical sensor may be disposed directly on a ceramic substrate. The control circuitry and/or other processing circuitry can be formed on the same substrate. Such a configuration may provide for improved compensation in the sensor as well as limit the potential for noise to be introduced into the sensor output. In some embodiments, the sensor elements can be coated with a water barrier and/or gas barrier, but may not otherwise comprise a housing. This may allow the sensor to be directly integrated with existing circuitry within an instrument. Various formation processes may be used to form the sensor on the ceramic or insulating substrate, which may allow for a relatively low cost alternative to the current electrochemical sensors.

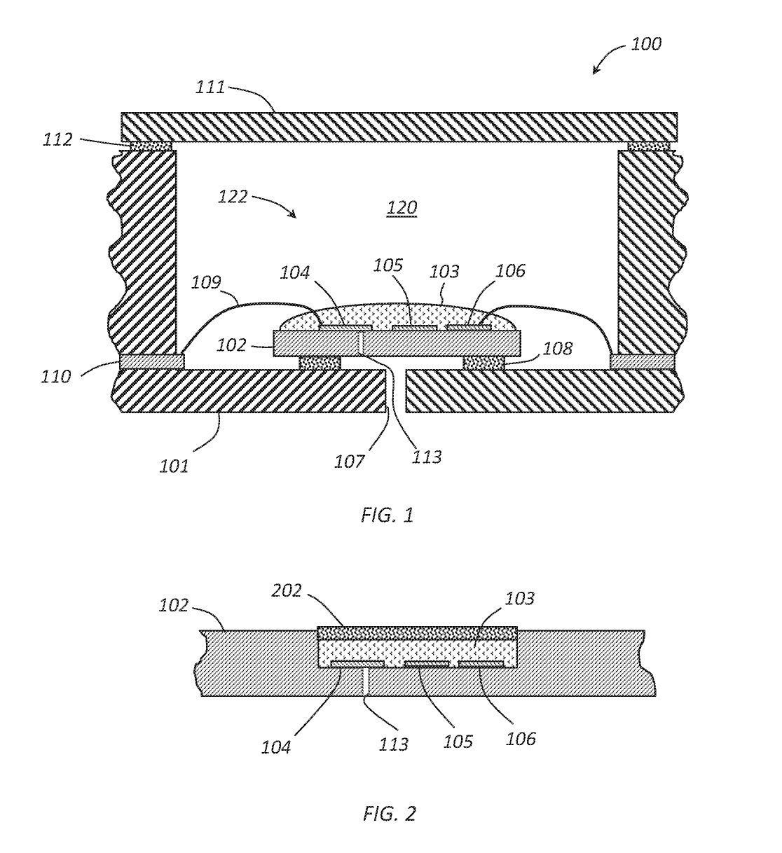

FIG. 1 illustrates a MEMS type electrochemical sensor 100. In this embodiment, the sensor can comprise a housing 101 coupled to a cap 111 having a sensing element 122 contained within a chamber 120 defined by an interior of the housing 101 and the cap 111. The sensing element 122 can comprise a substrate 102 having a plurality of electrodes such as a sensing electrode 104, a reference electrode 105 and a counter electrode 106 disposed thereon, and an electrolyte 103 disposed over at least a portion of each electrode 104, 105, 106. One or more leads 110 can be coupled by electrical conductors such as wires 109 to the electrodes 104, 105, 106 on the sensing element. The leads may extend through and be embedded within the housing 101. A capillary 113 can be disposed through the substrate to allow a gas to diffuse to the sensing electrode 104 and/or the electrolyte 103 (e.g., by providing fluid communication between the ambient environment and the sensing electrode 104 and/or the electrolyte 103). An opening 107 in the housing 101 may allow the ambient gases to access the capillary 113. Otherwise, the housing may be sealed, for example, using a sealant between the sensing element and the housing 101 and between the housing 101 and the cap 111.

The opening 107 in the housing may provide access for the gases outside of the housing 101 to enter the housing 101. In general, the opening 107 is intended to provide a controlled access to the chamber 120 without providing a diffusion limitation to gases entering the housing 101. In some embodiments, a filter material may be disposed in the opening 107 to keep dust or other materials out of the housing 101. In some embodiments, a diffusion membrane may be disposed over or within the opening 107 to provide a desired diffusion barrier to gasses entering the housing 101.

The housing 101 and/or the cap 111 can comprise any type of suitable material that serves to protect the sensing element 122 while also providing the sealed chamber 120 to prevent the ingress or egress of any ambient gases into the chamber other than through the capillary 113. The housing 101 and/or the cap 111 can be formed of a material that limits or prevents the loss of the electrolyte through the walls of the housing 101. The housing 101 and/or the cap 111 can be formed from materials that are inert to the selected electrolyte. For example, the housing 101 and/or the cap 111 can be formed from one or more plastic or polymeric materials. In an embodiment, the housing 101 and/or the cap 111 can be formed from a material including, but not limited to, acrylonitrile butadiene styrene (ABS), polyphenylene oxide (PPO), polystyrene (PS), polypropylene (PP), polyethylene (PE) (e.g., high density polyethylene (HDPE)), polyphenylene ether (PPE), or any combination or blend thereof. Other materials may also be suitable include metals, ceramics, or the like, which may depend on the environment into which the MEMS sensor may be used. For example, the housing 101 and the substrate 102 may be integrated components and formed from the same or similar materials. In some embodiments, the housing 101 and/or the cap 111 may be formed from the same or a similar material as the substrate 102, as described in more detail herein.

The housing 101 and the cap 111 can be sealed together using any suitable methods. In some embodiments, the housing 101 and the cap 111 can be coupled together using a joining process (e.g., ultrasonic welding, etc.) that can be used to fuse the two components to enhance the seal between the housing 101 and the cap 111. In some embodiments, a die attach material 112 such as a polymeric material (e.g., epoxies, resins, thermoset polymers, thermal polymers, etc.) or a solder can be used to join the housing 101 and the cap 111.

In some embodiments, the die attach material 112 may be permeable to one or more gases. For example, when the MEMS sensor 100 is used to detect oxygen in an oxygen pump configuration, oxygen may be generated at the counter electrode 106, which may evolve into the space within the chamber 120. The die attach material 112 may then serve as a vent material to allow the oxygen to diffuse out of the chamber 120. Alternatively, a vent material such as a polytetrafluoroethylene (PTFE) type material can be used in a vent hole in the housing 101 and/or the cap 111 to allow any oxygen or other gases to diffuse to the exterior of the chamber 120.

The sensing element 122 may be sealed to the housing 101 about the opening 107 using an additional amount of die attach material 108, which can include any of those materials described with respect to the material 112. The material 112 may be the same or different than the material 108. In some embodiments, the material 108 may be relatively compliant to reduce any shocks or other mechanical forces on the sensing element 122.

The MEMS substrate 102 may serve to support and retain the electrodes 104, 105, 106 and the electrolyte. The MEMS substrate 102 may also be chosen to be used with semiconductor manufacturing techniques. In an embodiment, the substrate 102 may comprise silicon, silicon nitride, silicon oxide, a doped silicon (e.g., doped with alumina (Al₂O₃), magnesia (MgO), quartz, gallium-nitride (GaN), or gallium arsenide (GaAs), or combination thereof), or any combination thereof. In an embodiment, the substrate 102 may be hydrophilic when an aqueous electrolyte is used. The resulting surface interactions between the substrate 102 and the water in the electrolyte may then help to retain the electrolyte in position on the substrate during use. The MEMS substrate 102 may be on a microscale dimension and may have dimensions (e.g., length and/or width) on the scale of 10 mm to about 10 μm, or between about 20 μm to about 5 mm.

The sensing electrode 104, the reference electrode 105, and the counter electrode 106 can be arranged in a co-planar, non-overlapping arrangement on the surface of the substrate 102. While shown in FIG. 1 as having three electrodes, the MEMS sensor 100 can also be used with only two electrodes including the sensing electrode 104 and the counter electrode 105. In some embodiments, four or more electrodes may also be present. For example, two or more sensing electrodes can be present and each sensing electrode may operate at a different potential to enable the detection of more than one target gas. Alternatively, four or more electrodes may be present to enable diagnostic tests to be conducted during operation of the MEMS sensor 100, continuously, periodically, or aperiodically. In some contexts, the sensing electrode 104 may also be referred to as a working electrode.

The composition, size, and configuration of the electrodes 104, 105, 106 can depend on the specific species of target gas or gasses being detected by the MEMS sensor 100. When semiconductor manufacturing techniques are used to form the MEMS sensor 100, the electrodes 104, 105, 106 may comprise materials capable of being deposited by such processes as thermal deposition, sputtering, chemical vapor deposition, etching, electrodeposition, or the like. For example, the electrodes 104, 105, 106 may comprise materials capable of being electrodeposited and etched to form the individual electrodes.

The electrodes 104, 105, 106 generally allow for various reactions to take place to allow a current or potential to develop in response to the presence of a target gas. The resulting signal may then allow for the concentration of the target gas to be determined. The electrodes can comprise a reactive material suitable for carrying out a desired reaction. For example, the sensing electrode 104 and/or the counter electrode 106 can be formed of one or more metals or metal oxides such as copper, silver, gold, nickel, palladium, platinum, ruthenium, iridium, tungsten, carbon, combinations thereof, alloys thereof, and/or oxides thereof. The reference electrode 105 can comprise any of the materials listed for the sensing electrode 104 and/or the counter electrode 106 and/or salts thereof, though the reference electrode 105 may generally be inert to the materials in the electrolyte in order to provide a reference potential for the sensor. For example, the reference electrode can contain a noble metal such as platinum and gold or a high conductivity metal/salt combination such as Ag/AgCl.

In some embodiments, one or more of the electrodes 104, 105, 106 can comprise a porous, gas permeable membrane. In this embodiment, the electrode (e.g., the sensing electrode 104), may be placed over the aperture or capillary 113. The gas diffusing through the capillary 113 may then contact and diffuse through the permeable membrane to react with the electrolyte at the opposite surface of the electrode. Such an electrode can be formed of any of the materials described herein. In addition to any of the materials for forming the electrode, various hydrophobic components such as PTFE can be combined with the electrode material and/or used as a backing layer (e.g., as a tape or support) for the electrode on the substrate 102. For example, sensing electrode 104 can comprise a catalyst such as platinum or carbon, supported on a PTFE membrane. In some embodiments, such as toxic gas sensors, the counter electrode 106 may comprise a catalyst mounted on a PTFE backing tape, in the same manner as the gas sensing electrode 104.

In some embodiments, the electrodes can comprise hydrophobic materials. Various coating such as PTFE coatings can be used to provide a hydrophobic surface while maintaining a degree of porosity for gas diffusion of the target gas. In some embodiments, the electrode material can be formed to exhibit hydrophobicity or superhydrophobicity. Various materials and preparation techniques are disclosed in U.S. Pat. No. 8,142,625 to Pratt, which is incorporated herein in its entirety, can be used to prepare a hydrophobic electrode or electrodes. In an embodiment, the electrode material can be formed using a template material to form a patterned surface for the electrode, where the pattern may impart hydrophobic properties to the electrode. The patterning material can include any suitable material that can be removed once the electrode is formed. In an embodiment, nanosized polymer spheres (e.g., nanosized latex spheres—which are commercially available) can be arranged on a suitable sacrificial substrate (e.g., a metal such as copper). The electrode metal can then be electroplated around the assembled spheres to produce a suitable hydrophobic surface. The resulting electrode surface may also have porosity for gas diffusibility. Plating bath additives may be added as appropriate. Alternatively, other templating techniques such as self-assembled surfactant molecules can be used. The templating material can then be subsequently removed, for example by dissolution, heat, or the like. The resulting electrode material can then be used for one or more of the electrode 104, 105, 106 while exhibiting hydrophobic properties.

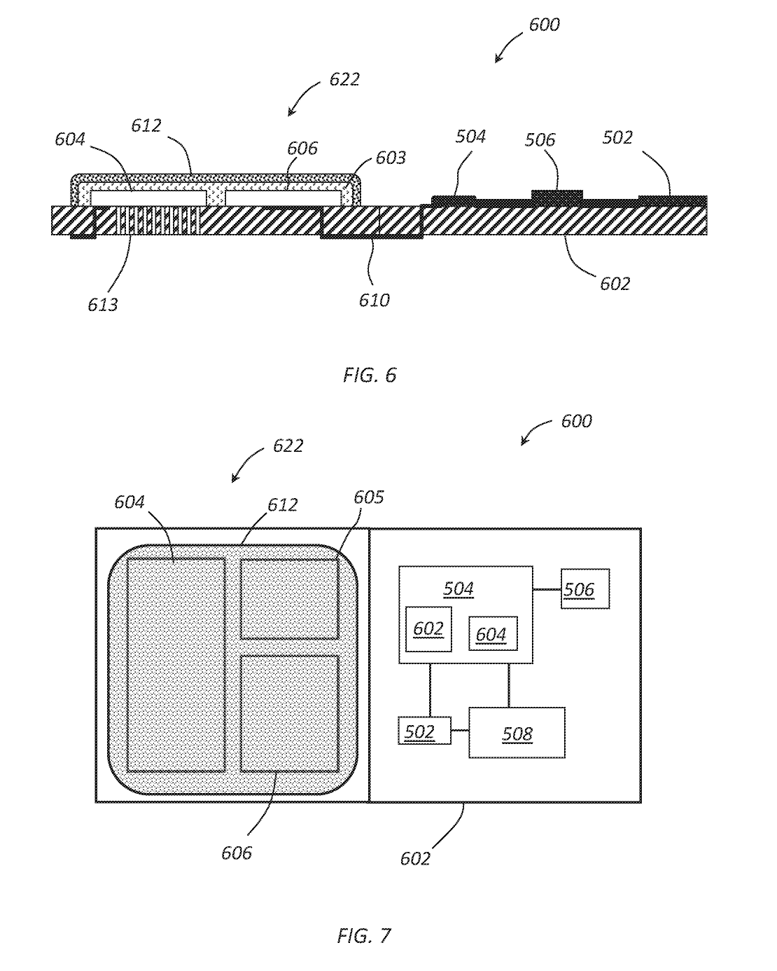

The electrodes 104, 105, 106 may be at least partially covered by or in contact with the electrolyte 103. Electrical contact can be made with an external contact lead 110 through one or more electrical conductors such as wires 109. The wires 109 can comprise foils, wires, or deposited materials on the substrate 102. The electrical conductors may comprise noble metals (e.g., platinum), such as by being formed from noble metals or coated with noble metals if the conductors are in contact with the electrolyte. In some embodiments, the electrical conductors may not be formed from noble metals if the electrical conductors are not in contact with the electrolyte 103. In some embodiments, the leads 110 may not pass through the electrolyte as shown in FIG. 1, but could be connected to exposed regions of the electrodes outside the electrolyte 103 and/or through the use of via holes or multiple layers to the same or opposite face of the substrate to avoid contact between the electrolyte 103 and the leads 110,as described in more detail with respect to FIG. 6. Any of the configurations of the leads described with respect to FIG. 6 can also be adapted for use with the sensor 100. The external contact leads 110 may be electrically coupled to control circuitry such as a potentiostat and/or detection circuitry external to the sensing assembly 122 and/or housing 101.

The electrolyte 103 may comprise any material capable of providing an electrically conductive pathway between the electrodes 104, 105, 106. The electrolyte 103 may be non-reactive with the substrate 102 material. If the electrolyte 103 and the substrate 102 can react, an insulting, non-reactive layer may be placed over the substrate prior to disposition of the electrodes 104, 105, 106 and the electrolyte 103. The electrolyte can comprise a liquid electrolyte, a gelled electrolyte, a solid electrolyte, or the like. In some embodiments, the electrolyte can be contained in or retained by a porous or absorbent material.

In an embodiment, the electrolyte can comprise any aqueous electrolyte such as a solution of a salt, an acid, and/or a base depending on the target gas of interest. In an embodiment, the electrolyte can comprise a hygroscopic acid such as sulfuric acid for use in an oxygen sensor. For example, the electrolyte can comprise sulfuric acid having a molar concentration between about 3 M to about 10 M. Since sulfuric acid is hygroscopic, the concentration can vary from about 10 to about 70 wt % (1 to 11.5 molar) over a relative humidity (RH) range of the environment of about 3 to about 95%. As another example, the electrolyte can include a lithium chloride salt having about 30% to about 60% LiCl by weight, with the balance being an aqueous solution. Other target gases may use the same or different electrolyte compositions.

In addition to aqueous based electrolytes, ionic liquid electrolytes can also be used to detect certain gases. The ionic liquids may have a greater viscosity than a corresponding aqueous electrolyte. In any of the electrolytes, a viscosifier may be added to provide an increased viscosity, which may aid in retaining the electrolyte in contact with the electrodes. In some embodiments, the electrolyte can be present in the form of a gel or a semi-solid.

In an embodiment, the electrolyte can comprise a solid electrolyte. Solid electrolytes can include electrolytes adsorbed or absorbed into a solid structure such as a solid porous material and/or materials that allow protonic and or electronic conduction as formed. In an embodiment, the solid electrolyte can be a protonic conductive electrolyte membrane. The solid electrolyte can be a perfluorinated ion-exchange polymer such as Nafion or a protonic conductive polymer such as poly(ethylene glycol), poly(ethylene oxide), poly(propylene carbonate). Nafion is a hydrated copolymer of polytretafluoroethylene and polysulfonyl fluoride vinyl ether containing pendant sulfuric acid groups. When used, a Nafion membrane can optionally be treated with an acid such as H₃PO₄, sulfuric acid, or the like, which improves the moisture retention characteristics of Nafion and the conductivity of hydrogen ions through the Nafion membrane. The sensing, counter and reference electrodes can be hot-pressed onto the Nafion membrane to provide a high conductivity between the electrodes and the solid electrolyte.

In some embodiments, the solid electrolyte can comprise a polymer matrix as the porous material and a charge carrying component within the polymer matrix. The charge carrying component can comprise a molecule that is smaller than the polymer matrix and is dispersed therein. The polymer itself can be nonconducting, and the polymer matrix can be non-ionic and/or non-ionizable, which may provide greater freedom of design for the acid host and allow the removal of the proton to be rendered more facile to improve the conductivity of the system. The use of the terms non-ionic and/or non-ionizable refers to the use of the solid electrolyte under normal operating conditions.

The polymer of the solid electrolyte system can be a homopolymer of vinylidene fluoride (PVdF) or copolymer of vinylidene fluoride with fluorinated co-monomers, for instance a copolymer of vinylidene fluoride and hexafluoropropylene (HFP), trifluoroethylene (VF₃) or chlorotrifluoroethylene (CTFE). The charge carrying component can comprise a fluorinated organic proton conductor dispersed in the polymer matrix. The fluorinated organic proton conductor can impart conductivity and is chosen to be chemically compatible with the polymer matrix to provide a high degree of solubility of the fluorinated organic proton conductor in the polymer. In an embodiment, the organic proton conductor can comprise a fluorinated sulphonic acid, or a fluorinated-sulphonamide. In some embodiments, the fluorinated organic proton conductor may be one or more of the following: heptadecafluorooctane sulphonic acid (Hepta), bis-trifluoromethane sulphonimide (Bis), N-(2,6-diethylphenyl)-1,1,1-trifluoromethane sulphonamide, N-benzyltrifluoromethane sulphonamide, N,N-cyclohexane-1,2-diylbis(1,1,1-trifluoromethanesulphonamide) and perfluoro (2-ethoxyethane)sulphonic acid and N-ethylperfluorooctylsulphonamide. A variety of additive can also be included in the polymer matrix. Additional details of the solid electrolyte are provided in U.S. Patent Application Publication No. 2004/0026246 to Chapples et al. and filed on Jul. 27, 2001, which is incorporated herein by reference in its entirety.

The solid electrolyte can also comprise one or more solid electrolyte materials. For example, if the gas to be detected is CO₂ and/or humidity, the solid electrolyte may be lanthanum oxide, La₂O₃. The solid electrolyte can be a layer of La₂O₃ or a layer of material (such as silica, for example) doped with La₂O₃, as desired. Other solid electrolyte materials can include, but are not limited to, a yttria stabilized zirconia (YSZ), K₂CO₃, Na₁₊ₓZr₂SiₓP₃₋ₓO₁₂, β-Al₂O₃(Na₂O_{.11}Al₂O₃), Li₃PO₄, LISICON(Li₂₊₂ₓZn₁₋ₓGeO₄), lithium phosphorous oxynitride, Li₂CO₃—MgO, Li₂SO₄, Li₄SiO₄, Li₁₄ZnGe₄O₁₆, γ-Li_{3.6}Ge_{0.6}V_{0.4}O₄, Li3N, Li-β-alumina Li₁₋ₓTi₂₋ₓMₓ(PO₄)₃ where (M=Al, Sc, Y or La), LGPS(Li₂GeP₂S₁₂) and LiₓLa_{(2-x)/3}TiO₃. The solid electrodes can be disposed on the substrate 102 using a metal mask or directly at a desired portion through a deposition process such as thermal deposition, sputtering, screen printing, a sol-gel process, chemical vapor deposition, atomic layer deposition, inkjet printing, or the like.

In some embodiments, a porous material such as a metal oxide that can be deposited on the sensing element 122. In some embodiments, various types of electrically insulating porous materials can be used to retain a liquid electrolyte, and may be placed on the sensing element 122 after the electrodes and remaining portions are manufactured. Such materials can include any of the types of materials used to form separators in electrochemical sensors such as glass (e.g., a glass mat), polymer (plastic discs), ceramics, or the like.

The electrolyte 103 can be disposed on the substrate 102 as a drop or in a solid form so that the electrolyte is in electrical contact with the electrodes 104, 105, 106. When the electrolyte 103 is in a liquid form, the interfacial interactions between the substrate and the electrolyte 103 may serve to retain the electrolyte 103 in position.

The capillary 113 controls the gas diffusion rate to sensing electrode 104. The size of the capillary 113 may vary depending on the target gas being measured. In an embodiment, the diameter of the capillary may be between about 0.5 μm and about 5 μm or between about 1 μm and about 3 μm. In some embodiments, the capillary 113 can be less than about 0.1 μm in diameter. In some embodiments, a gas permeable membrane such as a polytetrafluoroethylene could alternatively be used to control diffusion and may be used in place of or in addition to the capillary 113. For example, a gas permeable membrane can be used within or near the opening 107 in the body 101 to control the amount of gas reaching the capillary 113, thereby controlling the rate of gas diffusion to the electrodes. By controlling the diffusion rate, the capillary 113 also controls the availability of the target gas to the sensing electrode 104. For some target gases, the sensor 100 can be operated in a diffusion limited mode in which the diffusion rate becomes the limiting factor that controls the reaction rate for the reduction or oxidation of the target gas at the sensing electrode 104, which controls the current or potential generated by the sensing element 122.

The MEMS sensor 100 can be used to detect a variety of target gases where the electrode material and electrolyte composition can be selected for different target gases. The sensor 100 described above may be used in conjunction with other components and electronic instrumentation (e.g., electronic circuitry such as potential meters, current meters, potentiostats, and the like) to form an electrochemical sensor, that is capable of detecting gases or vapors that are susceptible to electrochemical oxidation or reduction at the sensing electrode, such as carbon monoxide, hydrogen sulphide, sulphur dioxide, nitric oxide, nitrogen dioxide, chlorine, hydrogen, hydrogen cyanide, hydrogen chloride, ozone, ethylene oxide, hydrides, and/or oxygen.

The MEMS sensor can be manufactured using semiconductor manufacturing techniques, which may allow a large number of sensors to be manufactured in a reproducible manner. In an embodiment, one or more substrates 102 can initially be formed. The substrates 102 may begin as a single sheet of substrate material such as silicon and be divided at the end of the processes. The capillary 113 may first be formed using an etching, drilling (e.g., mechanical drilling, laser drilling, etc.), or the like. The electrodes 104, 105, 106 can then be disposed on the substrate 102 using a suitable technique such as thermal deposition, sputtering, chemical vapor deposition, etching, electrodeposition, or the like. For example, the electrodes 104, 105, 106 may comprise materials capable of being electrodeposited as a single element and etched to form the individual electrodes. If the substrate is in a larger sheet, each substrate 102 can be separated before being placed in the housing and sealed to the housing over the opening 107 with the material 108. Once in the housing 101, the electrical connections 109 can be formed between the electrodes 104, 105, 106 and one or more electrical leads 110 to connect the sensing element 122 to the control and detection circuitry. The cap 111 can then be disposed over the housing 101 and sealed with the material 112 to form the chamber 120 can complete the sensor 100.

In use, the sensor can be used to detect a target gas. The target gas would enter the housing 101 through the opening 107, where the target gas is otherwise sealed out of the housing 101 due to the seals formed between the sensing element 122 and the housing 101 as well as the cap 111 and the housing 101. The target gas can diffuse into contact with the sensing electrode 104 through the capillary, where the capillary may serve as a diffusion barrier to limit the rate of diffusion of the target gas to the sensing electrode 104. Once the target gas reaches the sensing electrode, the target gas may undergo a reaction with the sensing electrode 104 and/or the electrolyte 103. Depending on the structure of the capillary 113, the sensing electrode 104, and/or the electrolyte, the target gas may react at a three-phase boundary between the electrode, the electrolyte, and the target gas. In response to the reaction of the target gas at the sensing electrode 104, a potential difference can be developed between the sensing electrode 104 and the counter electrode 106. The potential difference can be used to determine the concentration of the target gas.

In some embodiments, the electrode may be operated potentiostatically. In this embodiment, the reference electrode 105 may be used to maintain a desired potential between the sensing electrode 104 and the counter electrode 106. The reaction of the target gas may then produce a current through the circuit to maintain the potential. The current can be measured and used to determine the concentration of the target gas.

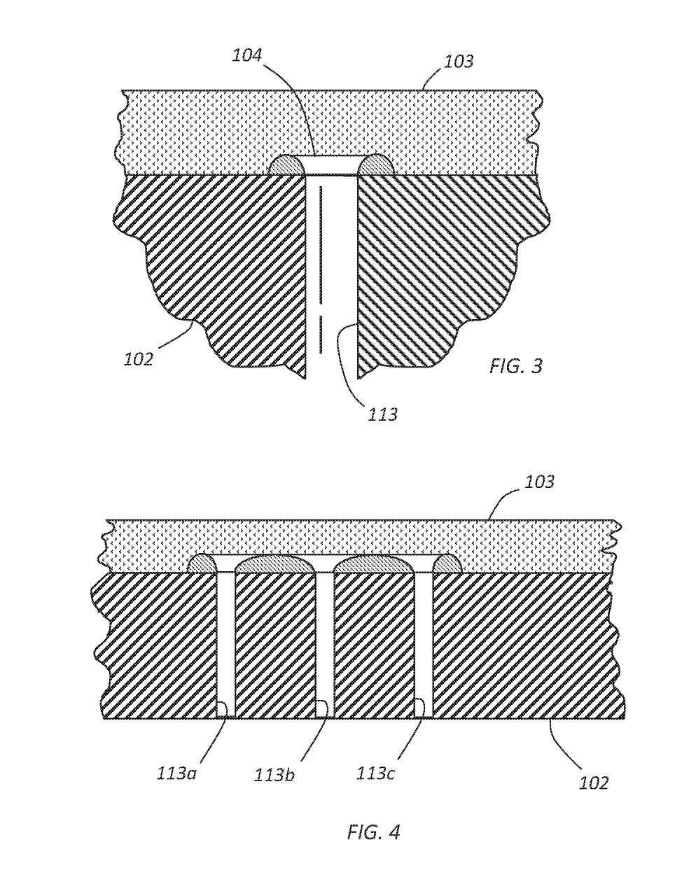

In some embodiments, the electrodes and electrolyte may be disposed within an etched substrate 102. FIG. 2 schematically illustrates a cross section of a substrate having an etched region for containing the electrodes 104, 105, 106 and the electrolyte 103. The elements shown in FIG. 2 may be the same as or similar to the elements described with respect to FIG. 1, and the similar components are not described in the interest of brevity. As shown in FIG. 2, the substrate 102 may be etched to form a recessed region for disposing the electrodes 104, 105, 106. The capillary 113 can be formed through the substrate in this region to provide access for the target gas to the sensing electrode 104 and/or the electrolyte 103. The electrolyte 103 can comprise any of the electrolytes described above. The electrolyte 103 can be disposed within and retained by the recessed region. The sensing element may otherwise be similar to the embodiments shown in FIG. 1.

As also shown in FIG. 2, an encapsulant 202 can be used to seal the electrolyte 103 in the recessed region. The encapsulant 202 can comprise any material suitable for bonding to the substrate and retaining the electrolyte in position on the substrate 102. In an embodiment, any of the die attach materials described herein can be used for the encapsulant. Additional materials such as silicone rubber or other polymeric materials can also be used as the encapsulant 202. Once disposed over the electrolyte 103 (e.g., a liquid electrolyte, a gelled electrolyte, and/or a solid electrolyte), the encapsulant may serve as a water vapor diffusion barrier to seal the electrolyte from the external environment. In some embodiments, the encapsulant may be flexible to allow the electrolyte volume to change over time, for example, in response to a gain or loss of water in a hygroscopic electrolyte. In this embodiment, a separate housing or cap may not be needed. This configuration may allow the MEMS sensor to be disposed directly in a larger chip or circuit board, where the substrate may form a portion of the overall board.

In some embodiments, the encapsulant 202 can comprise a parylene layer, a silicon layer, or any combination thereof. Examples of parylene, i.e., poly(para-xylylene), can include “Parylene N” or its substituted derivatives such as, “Parylene C,” and “Parylene D.” The Parylene “C” coating is para-xylyene with a chlorine atom substituted into its structure. The “C” variant of para-xylene is applied using a chemical vapor deposition (CVD) process, which may not require a “line-of-sight” for the coating at a pressure of 0.1 torr. There are numerous other parylene derivatives that may be suitable including Parylene AM, AF, SF, HT, X, E, VT, CF and more.

Other hydrophobic, chemically resistant coatings may also be useful as an encapsulant in any of the embodiments described herein. In general, any materials that perform as a good barrier for inorganic and organic solvents, strong acids, caustic solutions, gases, and water vapor may be used. When the sensor is used to detect oxygen in an oxygen pump configuration, the encapsulant may also allow for sufficient diffusion of oxygen to allow the oxygen to escape the sensor when generated at the counter electrode. If oxygen cannot escape in an oxygen sensor, for example if a completely hermetic barrier is used, then the reference potential can drift and/or the counter electrode may change its mechanism to hydrogen evolution rather than oxygen reduction in order to pass the required sensor current. Neither of these effects is desirable. Suitable barrier materials for an oxygen sensor can comprise those with a high ratio of oxygen to water transport, for example fluorinated polymers (e.g., PTFE, etc.) or polymers such as polypropylene, polyethylene etc. In cases where the electrolyte contains a hygroscopic material such as strong sulfuric acid as a humidification material, unless this can be isolated from the barrier material then the latter also needs to be chemically stable in the presence of the high acid concentrations that can exist under very dry conditions.

Other features of the encapsulant can include demonstrating electrical isolation with high tension strain and low dielectric constant, being micropore and pin-hole free, exhibiting thermal and mechanical stability, having very low permeability to gases, and demonstrating high electrical impedance. The encapsulant can be deposited over a layer of silicone. The encapsulant can be on the outer surface of the silicone layer that directly covers the electrolyte, including a solid electrolyte or electrolytes. The encapsulant can have a suitable thickness, and in some embodiments, the encapsulant can have a thickness of about one to about fifty micrometers. In another embodiment, the encapsulant can comprises a thickness of less than about ten micrometers.

In some embodiments, an additional, optional humidification layer can be deposited between the electrolyte 103 and the encapsulant 202. The humidification layer can act as a reservoir for water allowing the electrolyte and electrodes 104, 105, 106 to remain hydrated to improve operation under dry ambient conditions, without either the electrolyte 103 or the electrodes 104, 105, 106 being compromised (e.g., becoming flooded or diluting the electrolyte 103, etc.) under conditions of high humidity. In some embodiments, a hygroscopic additive, for example sulfuric acid, can be present in the humidification layer but not the electrolyte 103, for example when a solid electrolyte is used. This has the additional benefit that the properties of electrolyte 103 and the electrodes 104, 105, 106 can be optimized for their electrochemical performance without having to be chemically resistant to sulfuric acid (which can become highly concentrated in low humidity), whereas the humidification layer can be comprised of a material that is optimized for compatibility with the hygroscopic additive but does not need to perform any electrochemical function. In an embodiment, the humidification layer may comprise Polyvinylpyrrolidone (PVP) mixed with sulfuric acid and water. Other polymers and acids or other water retaining species and/or hygroscopic materials can also be used.

In an embodiment, the material used to form the substrate 102 may have a lower rate of water diffusion or transport than other materials used to form the housing 101. For example, silicon may have a lower diffusion rate of water than a polymer used to form a housing 101. As a result, the use of the substrate material to surround and enclose the electrolyte 103 may reduce the amount of water or other electrolyte 103 compositions lost during use. By providing a substrate having a recessed portion along with an encapsulant and/or housing over the substrate material, the loss of water or other materials can be reduced, which may extend the useful life of the sensor.

In some embodiments, the capillary 113 can extend through an electrode to provide direct gas access to the electrolyte disposed over the electrode. FIG. 3 illustrates a close up view of the capillary 113 passing through the substrate 102. In this embodiment, the electrode 104 may be formed around the opening of the capillary 113. The electrolyte 103 can then be exposed directly to the capillary 113 opening so provide a gas/electrolyte interface as well as a gas/electrolyte/electrode 104 interface. While shown as contacting electrode 104, the capillary can also provide access to the reference electrode 105 and/or the counter electrode 106 in some embodiments.

In this embodiment, the electrolyte 103 may be prevented from entering the capillary 113, which may limit or alter the ability of the target gas to diffuse to the electrode 104, due to the relatively small size of the capillary 113 and/or based on one or more surface modifications to make the surface of the capillary 113 and/or the electrode 104 hydrophobic. Any of the hydrophobic modifications including surface treatments, surface structuring, and the like can be used to make the surface of the capillary 113 and/or the electrode 104 hydrophobic. In some embodiments, the relatively small size of the capillary opening may allow only the surface of the electrode 104 to be hydrophobic. The surface of the electrode may provide a sufficient resistance to the entrance of the electrolyte into the capillary 113 that a treatment for the capillary may not be needed.

As shown in FIG. 3, the electrode 104 can be formed as a ring around the capillary 113 opening. While shown as a ring, the electrode 104 can also have any suitable shape about the opening of the capillary 113. For example, the opening of the capillary 113 may pass through any regularly shaped electrode to provide access between the target gas passing through the capillary 113 and the electrolyte 103.

An alternative embodiment is shown in FIG. 4. The embodiment illustrated in FIG. 4 is similar to the embodiment of FIG. 3, and the elements may be the same or similar, where the electrode 104 may be disposed on the substrate 102 and a plurality of capillaries 113a, 113b, 113c can be disposed through the substrate 102 and provide access between a target gas diffusing through the capillaries 113a, 113b, 113c and the electrolyte 103. Each capillary of the plurality of capillaries 113a, 113b, 113c may have the same diameter and/or one or more of the capillaries of the plurality of capillaries can have different diameters. The resulting configuration of the sensing element may resemble an array of microelectrodes.

While shown as providing access to the same electrode 104, one or more of the plurality of capillaries can also provide access through different electrodes and/or directly to the electrolyte without passing through an electrode. This may allow for an array of electrodes that are individually coupled to external circuitry to be used in the sensing element. Further, while three capillaries are illustrated, any number of capillaries can be used to provide a desired diffusion rate and location into the sensing element and/or into a specific electrode or area of the sensing elements.

In an embodiment, the surface of the substrate 102 around the opening of the capillary 113 may be hydrophobic to aid in the formation of the opening through the electrode during the formation of the sensor. During the formation process, the capillary 113 may be formed in the substrate 102 using any of the processes described herein. The surface of the substrate 102 around the capillary 113 and/or a portion or all of the interior surface of the capillary 113 can be made hydrophobic using any of the techniques described herein. When the electrodes are deposited on the substrate, the hydrophobicity may cause the electrode material to leave an opening through the electrode around the capillary opening. Further, any electrolyte that is added may also be repelled and not enter the capillary. In some embodiments, a solid electrolyte can be applied as a liquid or viscous gel and further viscosity or set after being deposited on the sensor. In these embodiments, the hydrophobicity may allow the solid electrolyte to be applied and form into the desired layer or shape, including being disposed over, but not in, the opening of the capillary.

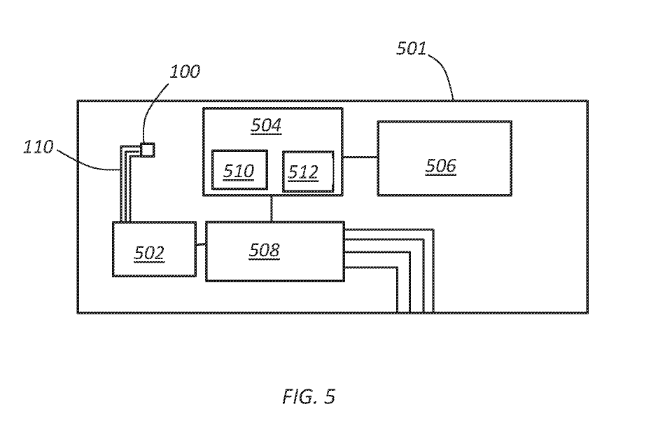

FIG. 5 illustrates the sensor 100 in the context of a larger circuit. The circuit can include a circuit board 501 can comprise a separate component from the sensor, a portion of the housing, or in some embodiments, an extension of the substrate such that the sensor 100 is formed on a single substrate that the other components are also disposed on. In this embodiment, the leads 110 may extend through a wall of the housing, and contact various external circuitry such as various sensing circuitry 506 (e.g. sensors, meters, etc.), a potentiostat 502, operating and control circuitry 504, communication circuitry 508, and the like. The sensor and meters can comprise additional sensors such as temperature and/or pressure sensors, which may allow for compensation of the sensor 100 outputs such that the compensation measurements are taken at or near the sensor 100 itself. Further, the location of the sensing circuitry 506 at or near the sensor 100 may allow smaller currents to be detected without intervening resistance, current loss, or electrical noise in longer electrical conductors. The control circuitry 504 may comprise a processor 510 and a memory 512 for performing various calculations and control functions, which can be performed in software or hardware. The communication circuitry 508 may allow the overall sensor results or readings to be communicated to an external source, and can include both wired communications using for example contacts on the board, or wireless communications using a transceiver operating under a variety of communication protocols (e.g., WiFi, Bluetooth, etc.). In some embodiments, the sensor 100 can be a separate component that is electrically coupled to external operating circuitry.

The sensor can also be implemented on a larger scale to form an integrated sensor assembly 600 on a ceramic substrate along with associated circuitry for operating the sensor. FIG. 6 schematically illustrates an embodiment of an integrated sensor assembly 600 disposed on a ceramic substrate 602. The integrated sensor assembly 600 may use a solid electrolyte 603 and electrodes 604, 606 on a ceramic substrate 602 to form an integrated sensor, which in some embodiments may not have a housing or other cover associated therewith. The overall integration of the sensing element 622 and the circuitry may provide for an overall small size and low cost as well as a reduced noise in the signal produced by the integrated sensor assembly 600. The reduced noise may be made possible by having shorter connection distances between the components and a reduction or elimination in the use of mechanical contact (e.g., mechanical connection of electrical conductors). The integrated sensor assembly 600 may also require less power than a sensor that requires separate mechanical connections to the control circuitry. The integrated sensor assembly 600 can be used to detect any of the target gases described with respect to the MEMS sensor herein.

The integrated sensor assembly 600 comprises two or more electrodes such as sensing electrode 604 disposed on a substrate 602, counter electrode 606, and a reference electrode (as shown in FIG. 7), an electrolyte 603, electrical leads 610 in electrical communication with the electrodes 604, 606, and one or more capillaries 613 disposed through the substrate 602. As noted herein, the use of a reference electrode is optional and the reference electrode may not be present in some embodiments. In addition, more than three electrodes may be present in some embodiments. An encapsulant 612 may be disposed over the electrolyte 603 to seal the electrolyte and electrodes 604, 606 from the ambient atmosphere so that the only fluid communication between the electrodes 604, 606 and the ambient environment is through the capillary 613. Other circuitry can also be disposed on the substrate 602 as described in more detail herein.

The substrate 602 serves to support and retain the sensing element 622. In the embodiment shown in FIG. 6, the substrate may function as a printed circuit board or other support for various circuitry. As a result, the substrate 602 may comprise an electrically insulating material. In some embodiments, the substrate 602 can comprise a ceramic such as alumina or silica, though other ceramic substrates can also be used. The use of a ceramic material may allow semiconductor manufacturing techniques to be used to produce the integrated sensor assembly 600.

The electrodes 604, 606 can include any of the materials and considerations described above with respect to the corresponding electrodes 104, 105, 106 of FIG. 1. The size of the electrodes 604, 606 may be larger than those formed on a MEMS device and can utilize various deposition techniques such as screen printing, thick film deposition, ink printing, and the like. In some embodiments, the electrodes may be formed using a single deposition layer of an electrode material followed by etching to form the final electrode structure. The resulting structure can include a co-planar arrangement of the electrodes 604, 606 on the substrate 602.

The electrolyte 603 can comprise any of the electrolytes described with respect to the electrolyte 103 of FIG. 1. In an embodiment, the electrolyte 603 can comprise a solid electrolyte, and the solid electrolyte can include any of the solid electrolytes described herein. The solid electrolyte can be deposited using various deposition techniques including thick film deposition. The electrolyte 603 can be disposed over at least a portion of each of the electrodes 604, 606 to provide a conductive pathway between the electrodes 604, 606.

The capillary 613 can be disposed through the substrate 602 to provide fluid communication between an ambient gas and one or more of the electrodes 604, 606 and the electrolyte 603. The capillary 613 can have a diameter selected to provide a desired diffusion rate through the substrate to one or more of the electrodes 604, 606 and/or the electrolyte 603. The capillary 613 can have a diameter greater than about 0.5 μm, greater than about 1 μm, greater than about 5 μm, greater than about 10 μm, greater than about 20 μm, greater than about 40 μm, greater than about 50 μm, greater than about 60 μm, greater than about 70 μm, or greater than about 80 μm. In some embodiments, the diameter of the capillary 613 may be less than about 200 μm, less than about 150 μm, less than about 100 μm, less than about 80 μm, or less than about 60 μm. In some embodiments, the diameter of the capillary 613 can be in a range extending from any of the lower capillary diameters to any of the upper capillary diameters. The capillary 613 can be formed through the substrate 602 using any known techniques including chemical etching, drilling (e.g., mechanical drilling, laser drilling, etc.), or any other suitable techniques.

The capillary 613 can be formed through the substrate 602 to align with one or more of the electrodes 604, 606. In an embodiment, the capillary 13 can provide a diffusional pathway to the sensing electrode 604. The sensing electrode 604 can extend across the opening of the capillary 613 or the sensing electrode 604 may have an opening to provide a path for a target gas to pass through the capillary and contact the electrolyte 603. In some embodiments, a plurality of capillaries may be present through the substrate 602. Any of the configurations of the capillaries and electrodes described with respect to FIGS. 3 and 4 can also apply to the embodiment illustrated in FIG. 6.

The encapsulant 612 can be placed over the components of the sensing assembly 622 to seal the sensing assembly 622 from the environment. The encapsulant 612 can be placed over the electrodes 604, 606 and the electrolyte 603. In some embodiments, an optional hydration layer can be included between the electrolyte 603 and the encapsulant 612 The encapsulant 612 may extend a distance around the electrodes 604, 606 and the electrolyte 603 sufficient to provide a seal over the components with the substrate 602. The capillary 613 may then be the only port for communication of a target gas to the electrodes 604, 606 and the electrolyte 603.

The encapsulant 612 may comprise any of the materials described herein with respect to the encapsulant 202 described with respect to FIG. 2. As noted herein, the encapsulant 612 may comprise a flexible or compliant material such as silicone rubber and/or parylene to accommodate any volumetric changes in the electrolyte 603. The solid electrolytes can absorb moisture and/or lose moisture depending on the humidity of the ambient environment. The thickness of the encapsulant may depend on the composition of the encapsulant 612 and the acceptable fluid loss through the encapsulant 612. The encapsulant layer can be thick enough so that the diffusion rate of one or more components of the electrolyte 603 is below an acceptable threshold. The encapsulant 612 can have any of the thicknesses described above with respect to the encapsulant 202 described with respect to FIG. 2.

As shown in FIG. 6, the use of the ceramic substrate 602 may allow for standard fabrication techniques to be used to form one or more of the components, ad described in more detail below. In some embodiments, the leads 610 can be formed on either surface of the substrate 602, through one or more vias or holes. As shown the lead 610 coupled to the counter electrode 606 may be formed between the counter electrode 606 and a first surface of the substrate 602. The lead 610 can then pass through a via to a second surface of the substrate 602 before connecting to various components. As shown in FIG. 6, the lead 610 may pass through a second via to contact the control circuit 504. Such a configuration may prevent the lead 610 from being in direct contact with the electrolyte 603, which may be beneficial in some embodiments. Such a configuration may also allow the encapsulant 612 to directly contact the substrate 602 around the electrodes 604, 606, which may help reduce the amount of moisture escaping the sensor assembly 622, which can occur at a leak point around any connections passing through the encapsulant 612 and/or between the encapsulant 612 and the substrate 602.

FIG. 7 illustrates a top plan view of the integrated sensor assembly 600 comprising the substrate 602 having the sensor assembly 622 disposed thereon in addition to the various circuitry such as a control circuit 504, one or more additional sensors or meters 506, a potentiostat 502, operating and control circuitry 504 including for example, processor 510 and/or memory 512, communication circuitry 508, and the like. The various circuitry and components can be the same or similar as the component described with respect to FIG. 5. In this embodiment, the substrate 602 is common to the various components. Additional vias or throughholes can be formed in the substrate as needed to provide electrical connections through the substrate as part of the circuit board. Solder and other components can be used as part of the formation process for the board as well as a connection means for coupling external circuitry to the substrate.

In some embodiments, more than one sensor assembly 622 can be disposed on a single substrate 602. For example, a plurality of individual sensor assemblies 622, each designed to detect the same or different target gases can be formed on a single substrate 602. The plurality of sensor assemblies 622 can use the same circuitry such as the same control circuitry, or alternatively, individual circuitry may be provided for each sensor assembly.

Any suitable manufacturing processes can be used to form the integrated sensor assembly 600. Referring to FIGS. 6 and 7, a manufacturing process for producing the sensor assembly 600 can begin be providing a substrate 602. The capillary or capillaries 613 can be formed through the substrate. If more than one sensing assembly 622 is used with the integrated sensor assembly 600, then the corresponding capillaries may be formed an initial process in the appropriate locations on the substrate 602. Any via holes or other holes through the substrate 602 can also be formed in the substrate 602.

In the next step, any printed circuit board tracks such as the leads, electrical connections between components, interface leads, PCB tracks, edge connectors, via holes, and the like can then be formed on the substrate 602. Additional components including resistors, capacitors, and the like can be fabricated directly on the substrate using semiconductor fabrication techniques or processes. Such processes can use a mask process, screen printing, etching, electrodeposition, or any other suitable process to form the printed circuit board tracks. In some embodiments, thick film screen printing can be used to form the various components on the substrate 602. Once the appropriate components are formed, any external components can be coupled to the substrate using solder, wirebonding, or other printed circuit board connection techniques. Since these processes usually involve the application of heat and use of chemicals that could contaminate the sensor materials (e.g., the electrodes, electrolyte, the encapsulant, etc.), the various portions of the integrated sensor assembly 600 may be formed prior to forming the sensing assembly or assemblies 622.

Once the portions of the board have been formed, the electrodes can be deposited using film deposition, screen printing, ink printing, or any of the other techniques described herein. The electrolyte can then be formulated and applied over the electrodes. As a final step, the encapsulant can be applied over the sensing assemblies 622 to seal the electrodes 604, 605, 606 and the electrolyte 603. If a hydration layer is present, it can be applied over the electrolyte prior to deposition of the encapsulant. A curing step can be carried out if need to cure the encapsulant or any other components. The sensing assembly or assemblies 622 and the integrated sensor assembly 600 may then be ready for use. The integrated sensor assembly 600 can be incorporated into a larger package or device or used as a stand-alone component.

While described as being fabricated in a certain order, the fabrication process can take place in a different order or using different fabrication techniques. For example, any external components that are coupled to the board can be coupled to the board after the sensor assembly 622 is formed (e.g., prior to or while incorporating the integrated sensor assembly 600 into a larger electronic assembly, etc.).

Having described various devices and methods herein, specific embodiments can include, but are not limited to;

In a first embodiment, an electrochemical sensor comprises: a ceramic substrate, a capillary disposed through the ceramic substrate; a plurality of electrodes disposed on a first surface of the substrate; an electrolyte disposed over at least a portion of each electrode of the plurality of electrodes; a coating disposed over the plurality of electrodes and the electrolyte, wherein the coating sealingly couples to the substrate over the plurality of electrodes and the electrolyte; and control and detection circuitry coupled to the substrate, wherein the plurality of electrodes are electrically coupled to the control and detection circuitry.

A second embodiment can include the electrochemical sensor of the first embodiment, wherein the ceramic substrate comprises alumina or silica.

A third embodiment can include the electrochemical sensor of the first or second embodiment, wherein the electrolyte comprises a solid electrolyte.

A fourth embodiment can include the electrochemical sensor of any of the first to third embodiments, wherein the capillary forms the only opening between an external environment and the plurality of electrodes.

A fifth embodiment can include the electrochemical sensor of any of the first to fourth embodiments, wherein the electrolyte comprises a thick film solid electrolyte.

A sixth embodiment can include the electrochemical sensor of any of the first to fifth embodiments, wherein the plurality of electrodes are disposed in a co-planar arrangement.

A seventh embodiment can include the electrochemical sensor of the sixth embodiment, wherein the coating is configured to enclose the plurality of electrodes and the electrolyte between the coating and the ceramic substrate.

An eighth embodiment can include the electrochemical sensor of any of the first to seventh embodiments, wherein the coating is a flexible coating.

A ninth embodiment can include the electrochemical sensor of any of the first to eighth embodiments, wherein the coating comprises silicone rubber, an epoxy resin, a thermoset polymer, a thermal polymer, or any combination thereof.

In a tenth embodiment, an electrochemical sensor comprises: a ceramic substrate, one or more capillaries disposed through the ceramic substrate; a plurality of electrodes disposed on a first surface of the substrate; a solid electrolyte disposed over at least a portion of each electrode of the plurality of electrodes, wherein the one or more capillaries form the only opening between an external environment and the plurality of electrodes; and control and detection circuitry coupled to the substrate, wherein the plurality of electrodes are electrically coupled to the control and detection circuitry.

An eleventh embodiment can include the electrochemical sensor of the tenth embodiment, wherein the one or more capillaries extend through the ceramic substrate from the first surface to a second surface opposite the first surface.

A twelfth embodiment can include the electrochemical sensor of the eleventh embodiment, wherein the one or more capillaries are configured to provide a diffusion pathway for a target gas to pass from an exterior of the housing to one or more of the plurality of electrodes.

A thirteenth embodiment can include the electrochemical sensor of any of the tenth to twelfth embodiments, wherein at least one capillary of the one or more capillaries comprises an opening on the first surface of the ceramic substrate, and wherein the opening is surrounded by a sensing electrode of the plurality of electrodes.

A fourteenth embodiment can include the electrochemical sensor of the thirteenth embodiment, wherein the sensing electrode forms a ring around the opening of the at least one capillary on the first surface of the ceramic substrate.

A fifteenth embodiment can include the electrochemical sensor of the fourteenth embodiment, wherein a surface of the sensing electrode is hydrophobic.

A sixteenth embodiment can include the electrochemical sensor of any of the tenth to fifteenth embodiments, further comprising a second capillary, a second plurality of electrodes disposed on the first surface of the substrate, and a second electrolyte disposed over at least a portion of each second electrode of the second plurality of electrodes, wherein the second plurality of electrodes are electrically coupled to the control and detection circuitry.

In a seventeenth embodiment, a method of forming an electrochemical sensor on a substrate comprises: forming one or more capillaries through a ceramic substrate; forming a plurality of electrical connection tracks on the ceramic substrate; coupling control and detection circuitry to the substrate, wherein the control and detection circuitry is electrically coupled to the plurality of electrical connection tracks; forming a plurality of electrodes on a first surface of the substrate, wherein the plurality of electrodes are in electrical communication with the control and detection circuitry; disposing a solid electrolyte over at least a portion of each of the plurality of electrodes; encapsulating the solid electrolyte and the plurality of electrodes; and sealing the plurality of electrodes and the electrolyte from an external environment based on the encapsulating, wherein the one or more capillaries form the only opening between the external environment and the plurality of electrodes.

An eighteenth embodiment can include the method of the seventeenth embodiment, wherein forming the plurality of electrodes occurs after coupling the control and detection circuitry to the substrate.

A nineteenth embodiment can include the method of the seventeenth or eighteenth embodiment, wherein coupling the control and detection circuitry to the substrate comprises applying heat to solder bond one or more components to the substrate.

A twentieth embodiment can include the method of any of the seventeenth to nineteenth embodiments, wherein disposing the solid electrolyte over at least the portion of each of the plurality of electrodes comprises screen printing the solid electrolyte.

A twenty first embodiment can include the method of any of the seventeenth to twentieth embodiments, wherein forming the plurality of electrodes comprising forming at least one electrode adjacent to an opening of at least one of the one or more capillaries on the first surface, wherein the at least one electrode is disposed about the opening of the at least one of the one or more capillaries.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1-15. (canceled)

16. An electrochemical sensor comprising:
a ceramic substrate;
a capillary disposed through the ceramic substrate;
a plurality of electrodes disposed on a first surface of the ceramic substrate;
an electrolyte disposed over at least a portion of each electrode of the plurality of electrodes;
a coating disposed over the plurality of electrodes and the electrolyte, wherein the coating seal couples to the ceramic substrate over the plurality of electrodes and the electrolyte, wherein the coating is configured to provide a hydrophobic surface while maintaining a degree of porosity for gas diffusion of the target gas; and
control and detection circuitry coupled to the same ceramic substrate as the plurality of electrodes, wherein the plurality of electrodes are electrically coupled to the control and detection circuitry.

17. The electrochemical sensor of claim 16, wherein the coating comprises a water vapor diffusion barrier to seal the electrolyte from the external environment.

18. The electrochemical sensor of claim 16, wherein the plurality of electrodes are electrically coupled to the control and detection circuitry through one or more leads, and wherein the leads pass through the ceramic substrate.

19. The electrochemical sensor of claim 16, wherein, when the sensor is used to detect oxygen, the coating allows diffusion of oxygen to allow the oxygen to escape the sensor when generated at the counter electrode.

20. The electrochemical sensor of claim 16, wherein the electrochemical sensor does not comprise a housing.

21. The electrochemical sensor of claim 16, wherein the plurality of electrodes and the control and detection circuitry are disposed in a co-planar arrangement.

22. The electrochemical sensor of claim 21, wherein the coating is configured to enclose the plurality of electrodes and the electrolyte between the coating and the ceramic substrate.

23. The electrochemical sensor of claim 16, wherein the coating is a flexible coating to allow the electrolyte volume to change over time in response to a gain or loss of water in a hygroscopic electrolyte.

24. The electrochemical sensor of claim 16, wherein the coating comprises silicone rubber, an epoxy resin, a thermoset polymer, a thermal polymer, or any combination thereof.

25. An electrochemical sensor comprising:
a ceramic substrate;
one or more capillaries disposed through the ceramic substrate;
a plurality of electrodes disposed on a first surface of the ceramic substrate;
a solid electrolyte disposed over at least a portion of each electrode of the plurality of electrodes, wherein the one or more capillaries form the only opening between an external environment and the plurality of electrodes; and
control and detection circuitry coupled to the same ceramic substrate as the plurality of electrodes, wherein the plurality of electrodes are electrically coupled to the control and detection circuitry through one or more leads, and wherein the leads pass through the ceramic substrate.

26. The electrochemical sensor of claim 25, wherein the one or more capillaries extend through the ceramic substrate from the first surface to a second surface opposite the first surface, and wherein the one or more capillaries are configured to provide a diffusion pathway for a target gas to pass from an exterior of the housing to one or more of the plurality of electrodes.

27. The electrochemical sensor of claim 25, wherein at least one capillary of the one or more capillaries comprises an opening on the first surface of the ceramic substrate, wherein the opening is surrounded by a sensing electrode of the plurality of electrodes, and wherein the sensing electrode form a ring around the opening of the at least one capillary on the first surface of the ceramic substrate.

28. The electrochemical sensor of claim 27, wherein a surface of the sensing electrode is hydrophobic.

29. The electrochemical sensor of claim 25, the lead passes through a via from a first surface to a second surface of the ceramic substrate before connecting to various components.

30. The electrochemical sensor of claim 29, wherein the lead passes through a second via, from the second surface to the first surface, to contact the control circuit, preventing the lead from being in direct contact with the electrolyte.

31. A method of forming an electrochemical sensor on a substrate, the method comprising:
forming one or more capillaries through a ceramic substrate;
forming a plurality of electrical connection tracks on the ceramic substrate;
coupling control and detection circuitry to the ceramic substrate, wherein the control and detection circuitry is electrically coupled to the plurality of electrical connection tracks;
forming a plurality of electrodes on a first surface of the ceramic substrate, wherein the plurality of electrodes are in electrical communication with the control and detection circuitry;
disposing a solid electrolyte over at least a portion of each of the plurality of electrodes;
encapsulating the solid electrolyte and the plurality of electrodes with a coating; and
sealing the plurality of electrodes and the electrolyte from an external environment based on the encapsulating, wherein the one or more capillaries form the only opening between the external environment and the plurality of electrodes.

32. The method of claim 31, wherein forming the plurality of electrodes occurs after coupling the control and detection circuitry to the ceramic substrate.

33. The method of claim 31, wherein coupling the control and detection circuitry to the ceramic substrate comprises applying heat to solder bond one or more components to the ceramic substrate.

34. The method of claim 31, wherein disposing the solid electrolyte over at least the portion of each of the plurality of electrodes comprises screen printing the solid electrolyte.

35. The method of claim 31, wherein forming a plurality of electrical connection tracks on the ceramic substrate comprises forming one or more vias through the ceramic substrate, passing a lead through the via of the ceramic substrate
